(19) United States
(12) Patent Application Publication
(10) Pub. No.: US 2007/0205577 A1
(43) Pub. Date: Sep. 6, 2007

(54) Human powered ground vehicle comprising foldable sections

(76) Inventor: James C.K. Lau, Torrance, CA (US)

Correspondence Address: KILYK & BOWERSOX, P.L.L.C., 3603 CHAIN BRIDGE ROAD, SUITE E, FAIRFAX, VA, 22030, US

(21) Appl. No.: 11/602,534

(22) Filed: Nov. 21, 2006

Related U.S. Application Data
(60) Provisional application No. 60/773,136, filed on Feb. 14, 2006.

(30) Foreign Application Priority Data
Mar. 7, 2006 (TW) 095107684

(51) Int. Cl. B62K 17/00

(52) U.S. Cl. 280/287; 280/278

(57) ABSTRACT

A human powered ground vehicle is provided and comprises a vehicle frame comprising a rear frame section and a mid-section, the mid-section comprising a forward end and a rearward end, wherein the rear frame section is pivotally connected at a sprocket assembly to the rearward end. Methods of folding and unfolding a foldable vehicle are also provided.

### CROSS-REFERENCE TO RELATED APPLICATIONS

This application claims the benefits of prior U.S. Provisional Patent Application No. 60/773,136, filed Feb. 14, 2006, and Taiwanese Patent Application No. 092107684, filed Mar. 7, 2006, both of which are incorporated herein in their entirety by reference.

### FIELD OF THE INVENTION

The present invention relates to human powered ground transportation vehicles having two or more wheels, such as bicycles and the like.

### BACKGROUND OF THE INVENTION

Today, bicycles enjoy wide recognition and favorable acceptance as a means of transportation. Bicycle design and construction has evolved tremendously over the years, and further evolution will likely continue long into the future.

The typical bicycle of today generally includes a metal frame mounted on two wheels with one behind the other, a seat, handlebars for steering, and a pair of pedals by which it is driven. The present day bicycles are constructed so that steering is accomplished via the forwardly positioned wheel and drive (power) for the vehicle is provided via the rearwardly positioned wheel. The overall length of such arrangements tends to exceed five feet. The vehicle weight is sometimes minimized by utilizing light weight materials, such as aluminum or fiber reinforced resins. Bicycle constructions which employ such materials can achieve vehicle weights as low as 10 pounds.

In spite of the widespread acceptance of bicycles as a means of transportation highly useful for many purposes, riders nevertheless often encounter problems upon reaching a destination point. For example, adequate facilities may not exist at a particular destination for storing the bicycle. Unfortunately, when a bicycle is temporarily parked and left unattended, it often becomes a target for theft and/or vandalism. Another problem can be encountered if the bicycle is used during, or in making, only a limited portion of a trip. In such a situation, the use and/or presence of the bicycle, especially a large and/or heavy one, will not always be desirable. For example, it may become necessary for a rider to carry the bicycle onto a different transportation vehicle for a time (e.g., a bus, van, train, plane, etc.). Such a situation could arise when the only reasonable means available to get to a particular desired location is by way of a common public transportation vehicle, but the rider contemplates a future need to use the bicycle after arriving at the location. It can be inconvenient to hand carry presently known ordinary bicycles, even if the present bicycles are constructed of very light weight materials. Many problems arise primarily as a result of vehicle length. Typical vehicle lengths are often equal to or greater than, average human height. Thus, problems caused merely by the spatial outlay of a vehicle can deter or prohibit a rider from carrying it about and/or stowing it safely away during periods of non-use (e.g., while at the workplace).

Development efforts, focused at reducing the vehicle carrying configuration length and width, have given rise to bicycle designs incorporating various folding schemes. So far, the reductions in carrying configuration size (volume) achieved by the known folding bicycles have not proven sufficient to promote their general recognition and acceptance.

As can be readily ascertained from the foregoing, various improvements in bicycle design and construction are desirable.

### SUMMARY OF THE INVENTION

The present teachings are adapted to be embodied in a human powered ground vehicle that can be advantageously foldable between a deployed operating configuration and a compactly folded configuration. According to various embodiments, the human powered ground vehicle can include a multi-section foldable vehicle frame. Furthermore, a carrying case comprising an interior compartment of sufficient size and shape to house the foldable vehicle frame, and adapted to be connected to the vehicle frame, can be provided. The vehicle can comprise a drive system that can comprise a derailleur system, a plurality of sprockets, a guide, and an adjustable chain tensioner.

According to various embodiments, a human powered ground vehicle can be provided. The vehicle can include a vehicle frame. The vehicle frame can comprise a mid-section having a forward end and a rearward end. A steering column that can extend across the vehicle frame can be provided. The steering column can be hingedly connected to a section of the vehicle frame. The steering column can extend transversely across the vehicle frame.

The vehicle can include a motive power input assembly supported by the frame. The motive power input assembly can be adapted to derive a motive power from physical exertion of force by a driver. In some embodiments, foot pedals coupled to the frame can be used to provide revolving or rotational motion about a pedal axis. The pedal axis can laterally extend transversely relative to the vehicle frame. A pedal axle can be disposed along the pedal axis. The pedal axle can support at least one pedal member adapted to revolve about it. The pedal member can travel or traverse through an area located behind, at, or forward of the steering column. The motive power input assembly can include at least two drive chains foldable at an intersection thereof, for example, foldable and/or pivotable at a sprocket assembly to which the chains are connected.

According to various embodiments, a method of storing a human powered ground vehicle is provided. The method can comprise one or more steps of: folding a steering column; folding pedals; folding a vehicle frame to form a folded vehicle frame; and placing the folded vehicle frame into an interior compartment of a carrying case.

Additional features and advantages of the present invention will become clear from the following description.

### BRIEF DESCRIPTION OF THE DRAWINGS

The structure and manner of operation of the present teachings, together with the further objects and advantages thereof, can be understood by reference to the following description taken in conjunction with the accompanying drawings, wherein identical reference numerals identify similar elements, and in which:

FIG. 1a is a top view of a two-wheeled human powered ground vehicle in a fully-erected operating configuration, according to various embodiments;

FIG. 1b is a side view of a two-wheeled human powered ground vehicle in a fully-erected operating configuration, according to various embodiments, and comprising a single speed gear system;

FIG. 2a is a top view of a vehicle according to various embodiments and in a folded configuration;

FIG. 2b is a top view of a vehicle according to various embodiments and comprising an multi-speed derailleur system, in a folded configuration;

FIG. 2c is a partial side view of a vehicle according to various embodiments and illustrating a folding operation involving a rear frame section of the vehicle frame;

FIG. 2d is a top plan view of a rear frame section according to various embodiments;

FIG. 2e is a side view of a rear frame section;

FIG. 3a is a side view of a folded configuration of an embodiment of a vehicle according to various embodiments; and

FIG. 3b is a side view of a partially folded configuration of an embodiment of a vehicle according to various embodiments.

Other embodiments of the present invention will be apparent to those skilled in the art from consideration of the present specification, practice of the invention described herein, and the detailed description that follows. It is intended that the specification and examples be considered as exemplary only, and that the true scope and spirit of the invention includes other various embodiments.

### DETAILED DESCRIPTION OF VARIOUS EMBODIMENTS

According to various embodiments, a human powered ground vehicle can be provided. The vehicle can include a vehicle frame comprising a mid-section having a forward end and a rearward end. A steering column can be hingedly connected to the vehicle frame. The steering column can extend transversely across the vehicle frame. The vehicle can include a motive power input assembly supported by the frame and adapted to derive a motive power from physical exertion of force by a driver. The motive power input assembly can include at least one pedal member adapted to revolve about a laterally extending axis that traverses the vehicle frame through an area located near the steering column. The means for transmitting power can include two chains. A first chain can transmit a rotational motion to a second chain at a sprocket assembly. The second chain can transmit rotational motion to a rear wheel.

The following teachings are merely exemplary in nature. Accordingly, these teachings are not intended to limit the scope of the various embodiments, application of the various embodiments, or the uses of the various embodiments.

The figures herein illustrate various embodiments of a human powered ground vehicle 10. The vehicle 10 can be provided with two wheels with a first or rear wheel 12 positioned behind a second or front wheel 14. Vehicles of this general type are popularly known (and can herein be referred to) as bicycles. Components or parts of vehicle 10 in common among various illustrated embodiments are identified by the same numerals in the various Figs.

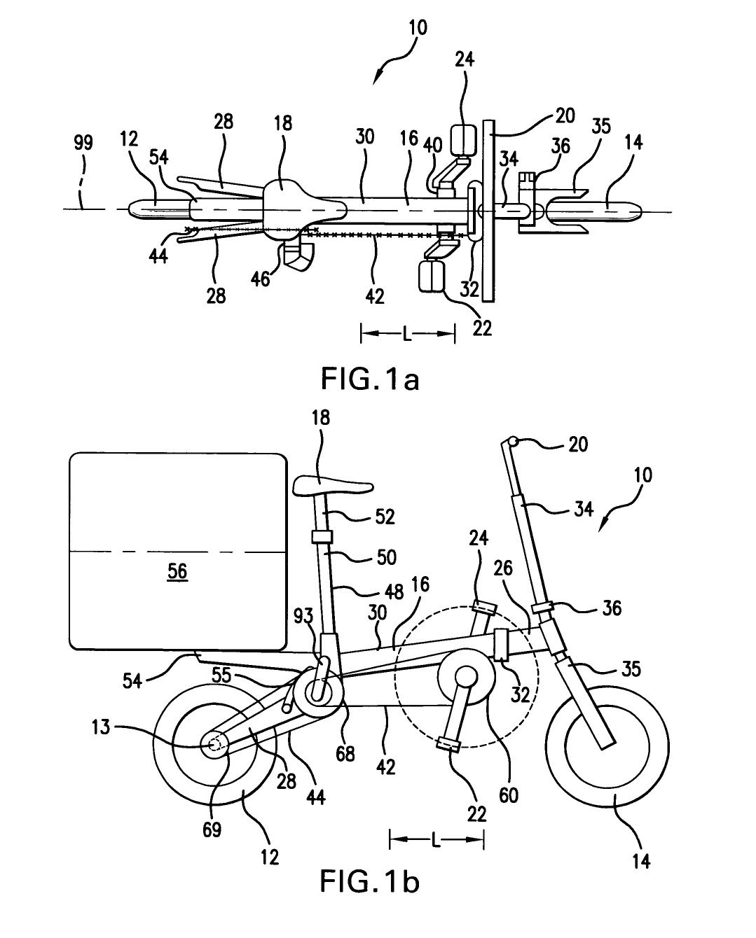

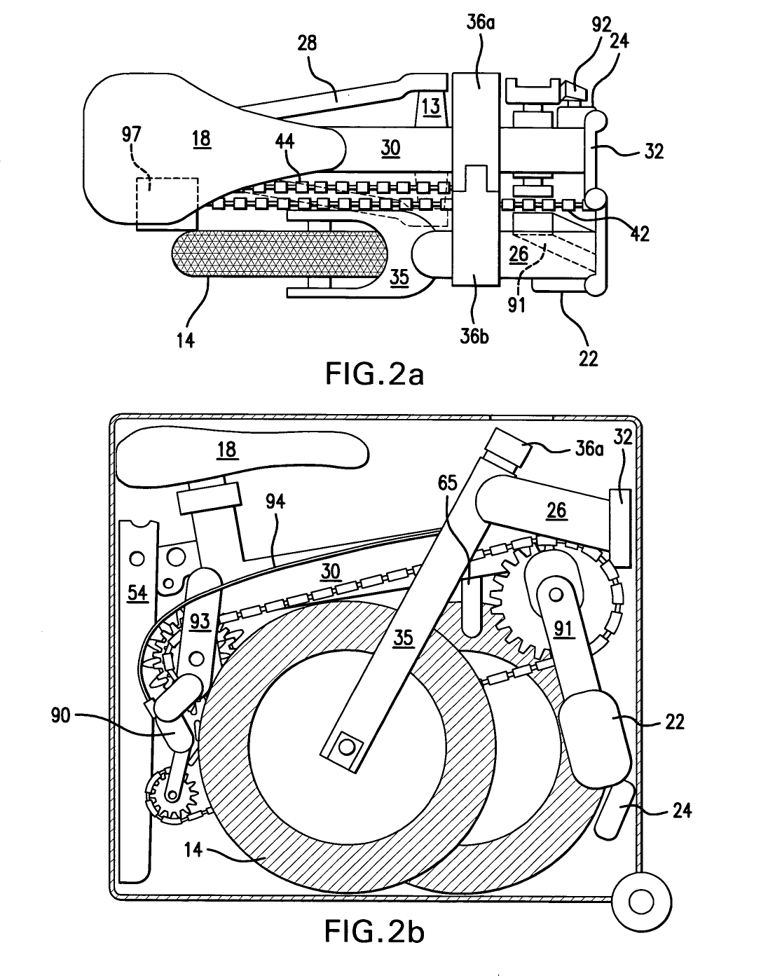

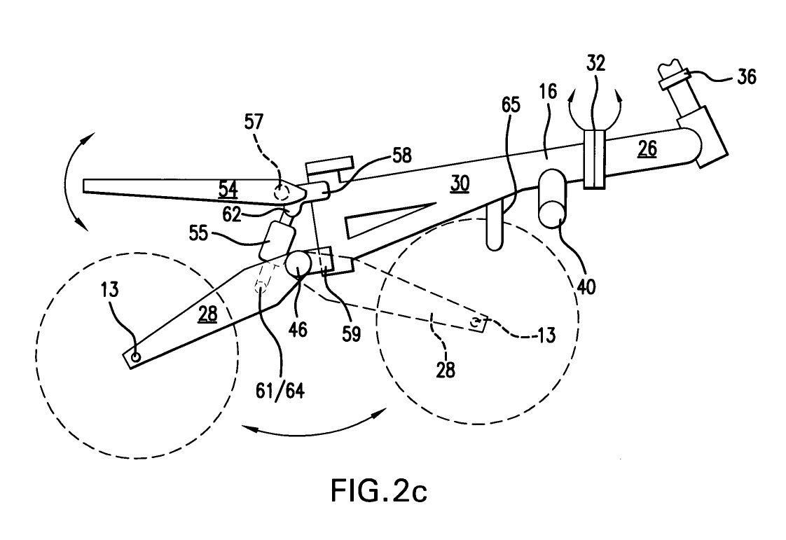

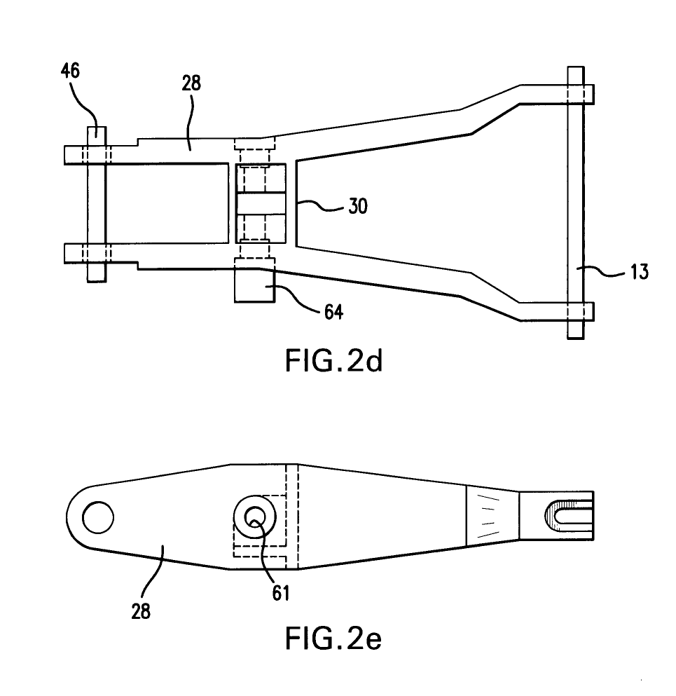

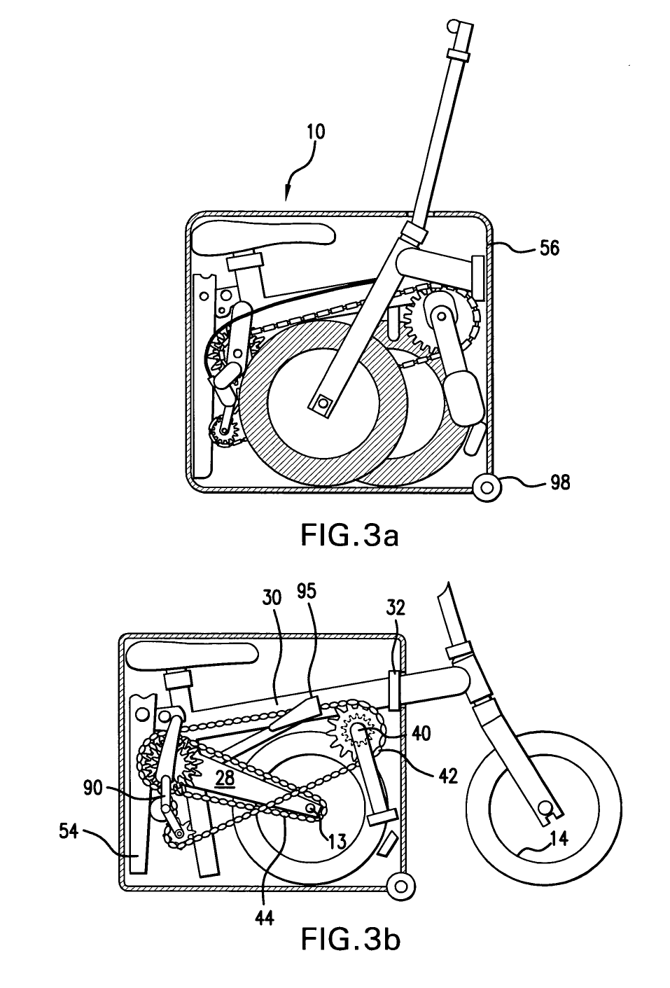

FIG. 1a illustrates an embodiment of vehicle 10 that comprises a multi-speed rear derailleur at an intermediate axle 46. FIG. 1b illustrates an embodiment of vehicle 10 depicting a single speed bicycle. FIG. 2b illustrates an embodiment of vehicle 10 that comprises a 6-speed rear derailleur to provide a six-speed bicycle. FIG. 3b illustrates an embodiment of vehicle 10 that comprises a modified front gearshift mechanism that can be used with a 2 or 3 sprocket gear set to double or triple the number of gear combinations.

Bicycle 10 of FIGS. 1a and 1b is depicted in a fully erected operating configuration. In FIG. 1a, the measurement scale designated with reference letter “L” measures a distance of approximately one foot along a longitudinal axis of the vehicle. Length “L” is merely set forth for illustrative purposes and is not intended to be limiting. It should be noted that the present teachings contemplate a variety of sizes, shapes, and various dimensions, for a vehicle constructed in accordance with the teachings set forth herein.

Bicycle 10 can comprise a number of basic components, for example, a vehicle frame mid-section 16 generally spanning the distance between rear wheel 12 and front wheel 14. A seat 18 can be provided to accommodate a rider. A handlebar 20 can be provided for steering. A right pedal 22 and a left pedal 24 can be provided to power the vehicle. The vehicle steering can allow manual turning of front wheel 14, as desired, via handlebar 20 and a steering column 34. With regard to driving or propelling vehicle 10, foot power can be applied to pedals 22, 24. The foot power can then be is transmitted to a wheel, for example, rear wheel 12, via a chain system comprising a first chain 42 and a second chain 44.

The unique design of the present teachings can provide an arrangement of elements that distinguishes bicycle 10 structurally from most commonly known bicycle constructions. The design can minimize the potential for incurring various inconveniences during efforts in transforming bicycle 10 between an erected/operating configuration and a compactly folded configuration.

It is quite likely that certain important structural features of the present teachings, as well as various advantages, are already apparent by way of the discussions and descriptions set forth above. Such features and advantages should become even clearer, and further advantages of the present teachings should be easily recognized and understood, upon studying the additional detailed description set forth below.

The vehicle frame can comprise a plurality of separate and distinct frame sub-components or sections. Particularly, the vehicle frame can include mid-section 16, a front section 26 (see FIG. 1b) located towards a forward end of vehicle 10, and a rear section 28 located towards a rearward or tail end of vehicle 10. Mid-section 16 can include a frame tube 30 that can span a distance that separates front section 26 and rear section 28. Upon proper alignment and connection of front section 26, mid-section 16, and rear section 28, the vehicle frame can perform as a single, unitary frame.

Front section 26, mid-section 16, and rear section 28 of the vehicle frame can each be adapted to act as means for supporting other vehicle-related components. The structure of front section 26, mid-section 16, and rear section 28, can be configured to accomplish, and/or allow desirable results and objectives, not usually associated with vehicle frames known in the art. A vehicle vertical center plane 9 can traverse the vehicle frame along its length, that is, longitudinally.

As depicted in FIGS. 1a and 1b, front section 26 of the vehicle frame can support front wheel 14 and steering column 34. A front fork 35 can be provided for front wheel 14. Mid-section 16 can include a front frame hinge 32. Pedal axle 40, right pedal 22, left pedal 24, first chain 42, intermediate axle 46, and seat post assembly 48 can be supported by mid-section 16 of the vehicle frame.

As seen in FIG. 1b, pedal axle 40 can accommodate a first sprocket 60. First sprocket 60 can comprise one or more sub-sprockets with different numbers of teeth or cogs. First sprocket 60 can comprise one, two, three, or more sub-sprockets. In various embodiments, intermediate axle 46 can accommodate, alone or in combination, a sprocket (not shown), a derailleur system 90 (see, FIG. 2b), and a hub gear 97 (see FIG. 2a) that can be driven by first chain 42. When first sprocket 60 comprises three sprockets at pedal axle 40 and a 7-gear rear derailleur is provided, bicycle 10 can have 21 gear combinations or speeds, for example, spaced equally apart. The gear combinations can provide peripheral chain lengths of from about 20 inches to about 120 inches. In some embodiments, intermediate axle 46 can accommodate a sprocket assembly 68. As intermediate axle 46 is spun by first chain 42, sprocket assembly 68 can drive second chain 44 transferring the pedal motive power to second chain 44. Second chain 44 can be connected to wheel sprocket 69 disposed at rear axle 13. The turning of wheel sprocket 69 can spin rear wheel 12, propelling the vehicle 10.

Rear frame section 28 can include suitable structural supports along the rearward vehicle area and can accommodate rear wheel 12. Rear section 28 can provide a mounting structure adapted to support second chain 44 and rear wheel 12. According to various embodiments, the rear wheel 12 can be mounted to spin freely about a rear axle 13.

In various embodiments, seat post assembly 48 can include two sliding sections 50, 52 (see FIG. 1b) to provide a height adjustment range for seat 18.

FIGS. 2a and 2b show the bicycle in a fully folded configuration. A right pedal pad 91 can be folded. A left pedal pad 92, behind right pedal arm 22 in FIG. 2a, can be folded near pedal axle 40 (FIG. 1a) to allow the folded configuration illustrated in FIG. 2b.

According to various embodiments, various locking and unlocking mechanisms known in the art can be used to provide a steering column hinge 36 for folding steering column 34. As seen in FIG. 2a, steering column hinge can be opened such that steering column 34 can be folded 180 degrees such that handle bar 20 can be laid adjacent front tire 14. By folding the steering column hinge, surfaces 36a and 36b of the steering column hinge can be exposed. Front frame section 26 can comprise a front frame hinge 32 adapted to rotate to the left or right of front frame section 26 for folding bicycle 10. Forward frame hinge 32 can use a locking pin, for example, as known in the art, to linearly align mid-section 16, and tubular member 30, with forward frame section 26.

In FIG. 2b, first chain 42 is visible. Second chain 44 is completely covered from view, by other components. Derailleur attachment bracket 93 can be used to ensure that first chain 42 is confined within a designed space. A derailleur control cable 94 can be used to connect a rear derailleur 90 to a gear selection controller (not shown), for example, a controller mounted on handle bar 20 or elsewhere on the vehicle frame. Seat 18 can be pushed down towards intermediate axle 46. Steering column 20 can be folded using hinge 36 (see FIG. 2a).

FIG. 2c is a partial side view of bicycle 10 illustrating a folding operation of the vehicle frame. FIG. 2c does not illustrate any sprockets, gears, or derailleur on the frame for the sake of simplicity. Rear frame section 28 can be pivoted in a counter-clockwise direction with respect to intermediate axle 46. Counter-clockwise rotation of rear frame section 28 with respect to intermediate axle 46 can position rear wheel 12 under mid-section 16. In various embodiments, a foldable chain of vehicle 10 can comprise two chains, namely, first chain 42 and second chain 44, as shown in FIG. 1b. Intermediate axle 46 can connect the two chains forming a folding pivot axis. According to various embodiments, the vehicle frame can comprise a custom made bicycle frame. Other components of bicycle 10 can comprise standard bicycle components available from various commercial suppliers. A bicycle capable of using a rear drive and comprising mostly off-the-shelf components with only a limited set of custom components can minimize costs to manufacture.

According to various embodiments, rear frame section 28 can comprise a spring-loaded locking pin 61. Spring-loaded locking pin 61 can be utilized as a shock absorber bottom pin and can be attached or affixed to the bottom of a shock absorber 55. In such an embodiment, rear frame section 28 can provide a hole or recess for spring-loaded locking pin 61 to extend into and lock rear frame section 28 into an operational configuration. Spring-loaded locking pin 61 can serve as a bottom connection for shock absorber 55. When bicycle 10 needs to be folded by a user, spring-loaded locking pin 61 can be compressed, for example, by human effort, to pull spring-loaded locking pin 61 away from a locking slot or recess. In an alternative embodiment, the spring-loaded locking pin 61 can be fixed or attached to rear frame section 28 and the locking slot can be disposed in shock absorber 55.

Rear frame section 28 can include a shock absorber 55 as shown in FIG. 2c. A top portion 62 of shock absorber 55 can be connected to a top lug 58. Top lug 58 can be connected to mid-section 16 of the vehicle frame. A bottom portion 64 of shock absorber 55 can be removably connected to rear frame section 28 using, for example, spring-loaded pin 61. Shock absorber 55 is not visible in FIG. 1a because it is covered by the sprockets and the folded shelf 54. In other embodiments, shock absorber 55 can be replaced by a rigid structural member (not shown) adapted to hold rear frame section 28 in an operational configuration. A bottom of the rigid structural member can be removably connected to rear frame section 28. Shock absorber 55 and/or the rigid structural member, with removable connectors, can be used to hold rear frame section 28 in an operational configuration.

In some embodiments, means or the adaptor connecting mid-section 16 to rear frame section 28 can enable rear frame section 28 to pivot around intermediate axle 46. Rear section 28 can be rotated to achieve optimal compactness as bicycle 10 is folded. In the embodiments shown in FIGS. 2a, 2b, 2c, 3a, and 3b, a single full-length sweep (i.e., beginning at one extreme end and continuing until the other extreme end is reached) of rear frame section 28 can be achieved as the rear frame section 28 angularly rotates along with second chain 44 and rear wheel 12, through a turn of about one-hundred and fifty degrees. In this way, rear frame section 28 can swing over a sufficient angular distance to reach a final folded position, under mid-section 16. Once in a folded position, rear frame section 28 can be substantially parallel to a generally vertical plane of mid-section 16. This construction can ensure that minimal dimensions are achieved once folded.

The pivotable rear frame section 28 of the present teachings does not impede a lowering of seat post 48. Further, pivoting rear frame section 28 more than 90 degrees can allow the folded dimensions of bicycle 10 to be smaller.

Rear frame section 28 can comprise a rear frame fork. A lock 65 can be affixed to mid-section 16 and can surround rear tire 12 to hold rear tire 12 in place by friction when bicycle 10 is in a folded configuration. The lock 64 can be U-shaped.

According to various embodiments, a luggage rack or shelf 54 can be disposed on the vehicle frame. In some embodiments, luggage rack 54 can be accommodated or attached to mid-section 16 of bicycle 10. Luggage rack 54 can be attached using a top lug 58 adapted to pivot on mid-section 16 around a luggage rack axle or pivot pin 57. Luggage rack 54 can be locked into an operating configuration using a luggage rack lock (not shown) that is adapted to keep luggage rack 54 in a lateral orientation. Luggage rack 54 can use various mechanisms known in the art to allow luggage rack 54 to pivot, for example, a locking pin, spring-loaded locking pin, a locking slot, a lug nut and bolt combination, or other mechanisms or combinations known in the art. A carrying case 56 can be disposed on top of and secured to luggage rack 54 (see FIG. 1b).

As shown in FIG. 3a, in some embodiments, steering column 36 can be left unfolded while the remainder of bicycle 10 is folded. Carrying case 56 can be used to enclose bicycle 10. Folded bicycle 10 can be disposed in carrying case 56 and thus easily transported. Folded bicycle 10 can be moved, for example, using a small wheel 98 disposed on carrying case 56. Carrying case 56 is shown in cross-section in FIG. 3a for illustration purposes only. When not in use, carrying case 56 can be disposed on luggage rack 54, for example, to be used as a luggage basket. Carrying case 56 can be hardback, soft-back, soft-back with a wire frame to shape the soft-back, or other embodiments known in the art. In FIG. 3b, a front derailleur mechanism 95 is included. Tow or more sprockets can be installed at the pedal axle in combination with derailleur mechanism 95 to provide a number of gear combination choices.

It is contemplated that steel, aluminum, an alloy, or a fiber reinforced plastic resin, or a combination thereof, can be used to construct frame 16. Of course, any other material, as considered suitable by those skilled in the art, may be used in the frame construction. Non-slip bolts, or other suitable means, can be provided to secure and maintain the vehicle frame sections in a deployed configuration according to various embodiments.

A general folding of bicycle 10, to reduce its overall length and height, can be carried out as follows. Initially, any means positionally interlocking the sections with one another are disengaged from the secured state. To affect the first fold, rear frame section 28 can rotate with respect to its associated horizontal axes around the bottom, thereby permitting the rear frame section 28 and the mid-section 16 of the frame to ultimately become parallel with one another. A second fold can be affected by rotating the front frame section 26 with respect to its associated vertical axis so that it achieves a substantial overlap relative to mid-section 16. Seat 18, foot pedals 22, 24, and handlebars 20 can be shifted from respective operating positions to stored positions. Appropriate locks can be provided for such purpose. Folded bicycle 10 can conveniently be hand carried and/or stowed out of the way, for example, under the seat of a passenger train, bus, van, airplane, or other public transportation means, for example, stored in carrying case 56.

In accordance with various embodiments, front steering column 34 can comprise front wheel 14, handlebars 20, and other control devices not specifically illustrated. These devices can comprise, for example, braking and gear shifting mechanisms and means. Steering column 34 can be connected to front frame section 26 by way of a hinge 36. One or more hinges (not shown) can also be provided along handlebar 20 to permit a folding of handlebar 20 to smaller dimensions.

Steering column 34 can be adapted for folding, for example, at its top portion. Particular folding and unfolding actions can be modified to satisfy different requirements determined according to the rider's body height, and/or any other special preferences.

The various vehicle frame sections described above can be made, for example, by machining aluminum materials (e.g., blocks) to the described configurations. Of course, it is desirable to use a low-cost production technique, appropriate for the chosen materials, in constructing the vehicle of the present teachings. Casting, stamping, stamp bending, and/or welding are contemplated as suitable production techniques. Stamping may be appropriate for plastic structural elements utilized in the bicycle. Any other production technique(s), as contemplated by a skilled artisan, may be employed.

It is contemplated that selective material removal, for a vehicle constructed according to the present teachings, at positions not essential to structural integrity or vehicle operation, can advantageously reduce vehicle weight. Vehicle weights of less than 20 pounds can be possible.

The vehicle can be operated in the deployed configuration shown in FIG. 1a. The following steps can be used to convert the vehicle from a folded configuration to its deployed operational configuration:

1. open the carry case and remove the folded vehicle;

2. rotate the front section of the frame with respect to the mid-section, and secure the forward frame hinge, for example, with a locking pin;

3. move the seat post up so that it will not block the rear section rotation.

4. rotate the rear section with respect to the rest of the frame, and lock it in place;

5. unfold the top portion of the steering column and the handlebars;

6. unfold the foot pedals;

7. adjust the seat to a desired position; and

8. attach the carry case to the luggage rack.

A reverse process can be used to fold the vehicle. FIG. 3b depicts the vehicle configuration after step 2. FIG. 3a depicts the vehicle configuration for towing the folded suitcase bicycle. The carrying case can cover the bicycle so that the internal components are actually not visible.

By using a 9-tooth sprocket for third sprocket 69 (see FIG. 1b), and using a 32-tooth sprocket at intermediate axle 46 (FIG. 1a), movement of second chain 44 can cause rear wheel 12 to rotate more than three-times with one revolution of second sprocket 68. In some embodiments, second chain 44 can be placed closer to the vehicle centerline than first chain 42. Using a 26-tooth sprocket for first sprocket 60 (FIG. 1b) at pedal axle 40 and an 11-tooth sprocket at intermediate axle 46 for first chain 42 can cause the overall gear combination to provide a chain pathway of about 100 inches. Using a 23-tooth sprocket at pedal axle 40, a 29-tooth sprocket at intermediate axle 46, and the same second chain (32 to 11) can cause the overall gear combination to provide a chain pathway of 34 inches. It is possible to select the sprockets used for first chain 42 to achieve almost any gear combination. A 21-speed derailleur system can be set up to allow for shifting to almost any desirable gear combination.

The following is an example of a 21-speed arrangement. At pedal axle 40, sprockets containing 30, 28, and 26 teeth can be installed. At intermediate axle (46), sprockets of 11, 13, 16, 20, 24, 29, and 34 teeth can be installed. The following chain pathways can be achieved:

The top gear is (30/11)(32/9)(12)=115.4 (inches).

The second gear is (28/11)(32/9)(12)=108.6.

The third gear is (26/11)(32/9)(12)=100.8.

The Fourth gear is (30/13)(32/9)(12)=98.5.

The fifth gear is (28/13)(32/9)(12)=91.1.

The sixth gear is (26/13)(32/9)(12)=85.5.

The seventh gear is (30/16)(32/9)(12)=80.

The eighth gear is (28/16)(32/9)(12)=74.7

The lowest gear (21st) is (26/34)(32/9)(12)=32.6.

Some gear combinations (such as the third gear and the fourth gear) can be very close to each other. This example includes no less than 15 gear combinations with less than 10 percent difference between adjacent gear combinations.

The rear derailleur, with multiple sprockets, indicated as 90 in FIG. 2b, is readily available from many suppliers.

An alternate method to achieve multiple gear combinations is to use hub-gears or modified hub-gears. For the double chain design, the gear selection component which is a modified hub gear 97 (see FIG. 2a) mounted at the position of intermediate axle 46. In FIG. 2a, the derailleur has been replaced by modified hub gear 97. Placing the hub gear at the rear wheel can require an extra fold in a hub gear control cable. The control cable can accommodate the minimum number of folding steps. The rear sprocket for first chain 42, the rear derailleur sprocket set, and the modified hub gear can be interchangeable provided a corresponding first chain 42 of a correct length is selected.

According to various embodiments, a method of folding a human powered ground vehicle is provided. The method can comprise: unsecuring a rear frame section from a vehicle frame by releasing a lock; pivoting the rear frame section at an intersection of a forward chain and a rear chain with respect to the vehicle frame, such that the rear-frame section is disposed below the vehicle frame and a portion the rear chain is closer to a vehicle vertical center plane than the forward chain; and securing a rear tire against the vehicle frame. In some embodiments, the method can comprise folding a vehicle frame front section alongside a mid-section of the vehicle frame, such that a portion of a front tire of the vehicle is placed rearward of a foot pedal. In other embodiments, the method can comprise one or more of: folding top portion of a steering column; folding a handlebar; folding a foot pedal; folding a luggage rack; raising and then lowering a seat post; placing a folded vehicle in a carrying case; and using the steering column as a handle to push or pull a folded vehicle.

According to various embodiments, a method of unfolding a human powered ground vehicle is provided. The method can comprise: unsecuring a rear wheel from a vehicle frame; pivoting a rear frame section around an intersection of a forward chain and a rear chain, with respect to the vehicle frame, such that the rear-frame section that was disposed below the vehicle frame is pivoted in-line with the vehicle frame; and securing the rear frame section to the vehicle frame by engaging a lock.

According to various embodiments, there is no need to remove the seat post for the bike to fit in its carrying case. There can be different folding options to carry around the folding bicycle. In some embodiments, the bicycle can accommodate riders that are from about four feet tall to about about six and a half feet tall. The folded dimensions can be, in some embodiments, 22.5 inches long, 19.5 inches wide, and 9.1 inches high. The weight can be 25 pounds or less in some embodiments. The tires can be pneumatic tires, for example, 12 inch pneumatic tires that are designed to hold about 40 psi. The bicycle can have a 39 inch or longer wheel base in some embodiments. A five speed transmission can be used, with a gear combination of from about 41 to about 93 inches, in some embodiments.

Those skilled in the art can appreciate from the foregoing description that the broad teachings can be implemented in a variety of forms. Therefore, while this invention has been described in connection with particular embodiments and examples thereof, the true scope of the teachings should not be so limited. Various changes and modifications may be made without departing from the scope of the claimed invention.

What is claimed is:

1. A human powered ground vehicle comprising:
a vehicle frame comprising a rear frame section and a mid-section, the mid-section comprising a forward end and a rearward end, the rear frame section pivotably connected to the rearward end;
at least one pedal member connected to the mid-section and comprising a pedal and a sprocket adapted to revolve about a lateral axis that traverses the mid-section adjacent the forward end;
a rear wheel mounted for rotation on the rear frame section and comprising a wheel sprocket;
a sprocket assembly comprising at least a first sprocket for a first chain and a second sprocket for a second chain;
a first chain drivingly connecting the pedal sprocket to the first sprocket; and
a second chain drivingly connecting the second sprocket and the wheel sprocket;
wherein the rear frame section is adapted to pivot at the sprocket assembly.

2. The human powered ground vehicle of claim 1, further comprising a lock disposed on the mid-section and adapted to secure the rear frame section such that the mid-section and the rear frame section are co-planar along a longitudinal plane.

3. The human powered ground vehicle of claim 1, further comprising a forward section hingedly connected to the mid-section and comprising a foldable steering column hingedly connected to the mid-section and disposed at an intersection with the forward end.

4. The human powered ground vehicle of claim 1, wherein the rear frame section pivots downwardly to a position below the mid-section.

5. The human powered ground vehicle of claim 1, wherein the sprocket assembly comprises a derailleur system and the derailleur system comprises two or more sprockets to drive the first chain.

6. The human powered ground vehicle of claim 5, wherein the derailleur system comprises a controller configured to control the first chain.

7. The human powered ground vehicle of claim 5, wherein the derailleur system comprises a controller configured to control the second chain.

8. The human powered ground vehicle of claim 1, wherein the second sprocket is disposed closer to a center plane of the mid-section than is the first sprocket.

9. The human powered ground vehicle of claim 1, further comprising a pivotable luggage rack secured to the vehicle frame.

10. The human powered ground vehicle of claim 9, further comprising a carrying case adapted to hold the vehicle in a folded configuration and adapted to be secured onto the pivotable luggage rack.

11. The human powered ground vehicle of claim 1, further comprising a carrying case comprising one or more rollers, wherein the carrying case is configured to hold the human powered ground vehicle in a folded configuration.

12. The human powered ground vehicle of claim 11, further comprising a foldable steering column adapted to extend from the carrying case to pull or push the human powered ground vehicle when the human powered ground vehicle is in a folded configuration in the carrying case.

13. The human powered ground vehicle of claim 1, further comprising a shock absorber disposed at an intersection of the mid-section and the rear frame section.

14. A method of folding a human powered ground vehicle comprising:
unlocking a rear frame section of a vehicle frame relative to a mid-section of a vehicle frame by releasing a lock, the mid-section comprising a sprocket assembly; and
pivotally moving the rear frame section at the sprocket assembly such that the rear frame section is pivoted to a position below the mid-section.

15. The method of claim 14, further comprising folding a forward section, comprising a front tire, alongside the mid-section, such that a portion of a front tire is disposed rearward of a foot pedal connected to the vehicle frame.

16. The method of claim 14, further comprising one or more of:
folding a top portion of a steering column;
folding a handlebar;
folding a foot pedal;
folding a luggage rack;
raising and then lowering a seat post;
placing the vehicle, while in a folded configuration, in a carrying case; and
using the steering column as a handle to push or pull the human powered ground vehicle in a folded orientation.
